(19) United States
(12) Patent Application Publication
(10) Pub. No.: US 2025/0271693 A1
(43) Pub. Date: Aug. 28, 2025

(54) ELECTRONIC DEVICE

(71) Applicant: Innolux Corporation, Miaoli County (TW)

(72) Inventors: Jyun-Sian Li, Miaoli County (TW); Hong-Sheng Hsieh, Miaoli County (TW)

(73) Assignee: Innolux Corporation, Miaoli County (TW)

(21) Appl. No.: 19/023,412

(22) Filed: Jan. 16, 2025

(30) Foreign Application Priority Data
Feb. 26, 2024 (CN) 202410210415.5

(51) Int. Cl. G02F 1/13; G02F 1/1335; G02F 1/13363

(52) U.S. Cl. CPC G02F 1/1323; G02F 1/133531; G02F 1/13363

(57) ABSTRACT

An electronic device includes a first viewing angle control panel and a second viewing angle control panel. The first viewing angle control panel includes a first liquid crystal layer. The first liquid crystal layer has a first liquid crystal refractive index difference value, a first liquid crystal layer spacing, and a first liquid crystal average alignment direction. The second viewing angle control panel overlaps the first viewing angle control panel and includes a second liquid crystal layer. The second liquid crystal layer has a second liquid crystal refractive index difference value, a second liquid crystal layer spacing, and a second liquid crystal average alignment direction. A product of the first liquid crystal refractive index difference value and 10 the first liquid crystal layer spacing is different from a product of the second liquid crystal refractive index difference value and the second liquid crystal layer spacing, and the first liquid crystal average alignment direction is different from the second liquid crystal average alignment direction.

### CROSS-REFERENCE TO RELATED APPLICATION

This application claims the priority benefit of China application serial no. 202410210415.5, filed on Feb. 26, 2024. The entirety of the above-mentioned patent application is hereby incorporated by reference herein and made a part of this specification.

### BACKGROUND

### Technical Field

The disclosure relates to an electronic device.

### Description of Related Art

At present, anti-peeping products have a large anti-peeping range requirement in terms of specifications. For example, car screens have anti-peeping requirements within a viewing angle range of 30-60 degrees. However, current anti-peeping designs have weak anti-peeping abilities at small viewing angles (for example, the viewing angle is less than 40 degrees).

### SUMMARY

The disclosure is directed to an electronic device, which helps to improve an anti-peeping ability of small viewing angles.

An embodiment of the disclosure provides an electronic device including a first viewing angle control panel and a second viewing angle control panel. The first viewing angle control panel includes a first liquid crystal layer. The first liquid crystal layer has a first liquid crystal refractive index difference value, a first liquid crystal layer spacing, and a first liquid crystal average alignment direction. The second viewing angle control panel overlaps the first viewing angle control panel and includes a second liquid crystal layer. The second liquid crystal layer has a second liquid crystal refractive index difference value, a second liquid crystal layer spacing, and a second liquid crystal average alignment direction. A product of the first liquid crystal refractive index difference value and the first liquid crystal layer spacing is different from a product of the second liquid crystal refractive index difference value and the second liquid crystal layer spacing, and the first liquid crystal average alignment direction is different from the second liquid crystal average alignment direction.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A is an exploded view of an electronic device according to a first embodiment of the disclosure.

FIG. 1B is a schematic cross-sectional view of a first viewing angle control panel or a second viewing angle control panel in FIG. 1A.

FIG. 2 to FIG. 4 are respectively schematic top views illustrating three relative arrangements of a liquid crystal average alignment direction, a first alignment direction of a first alignment layer, and a second alignment direction of a second alignment layer.

FIG. 5 is a diagram illustrating a relationship between a liquid crystal average alignment shift angle, Δnd and a viewing angle at minimum brightness.

FIG. 6 is a diagram illustrating a relationship between viewing angles and brightness percentage.

FIG. 7 is an exploded view of an electronic device according to a second embodiment of the disclosure.

FIG. 8 to FIG. 10 are three schematic top views respectively illustrating three relative

arrangements of the liquid crystal average alignment direction and a second direction.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

Certain terms are used throughout the specification of the disclosure and the appended claims to refer to specific components. Those skilled in the art should understand that electronic device manufacturers may probably use different names to refer to the same components. This specification is not intended to distinguish between components that have the same function but different names. In the following specification and claims, the terms “including”, “containing”, “having”, etc., are open terms, so that they should be interpreted as meaning of “including but not limited to . . . ”.

Directional terminology mentioned in the specification, such as “top”, “bottom”,

“front”, “back”, “left”, “right”, etc., is used with reference to the orientation of the figures being described. Therefore, the used directional terminology is only illustrative, and is not intended to be limiting of the disclosure. In the figures, the drawings illustrate general characteristics of methods, structures, and/or materials used in specific embodiments. However, these drawings should not be construed as defining or limiting of a scope or nature covered by these embodiments. For example, for clarity's sake, a relative size, a thickness and a location of each film layer, area and/or structure may be reduced or enlarged.

One structure (or layer, component, or substrate) described in this disclosure is located on/above another structure (or layer, component, or substrate), which may mean that the two structures are adjacent and are in direct connection, or mean that the two structures are adjacent and are in indirect connection. The indirect connection means that there is at least one intermediate structure (or intermediate layer, intermediate element, intermediate substrate, or intermediate spacer) between the two structures, a lower surface of one structure is adjacent to or directly connected to an upper surface of the intermediate structure, and an upper surface of the other structure is adjacent to or directly connected to a lower surface of the intermediate structure.

The intermediate structure may be composed of a single-layer or multi-layer physical structure or non-physical structure, which is not limited by the disclosure. In the disclosure, when a structure is disposed “on” another structure, it may mean that the structure is “directly” on the other structure, or that the structure is “indirectly” on the other structure, i.e., at least one structure is further sandwiched between the structure and the other structure.

The terms “about”, “substantially” or “approximately” are generally interpreted as within 10% of a given value or range, or as within 5%, 3%, 2%, 1% or 0.5% of a given value or range. In addition, the terms “a range is a first value to a second value” and “a range is between a first value and a second value” mean that the range includes the first value, the second value and other values therebetween.

The ordinal numbers such as “first”, “second”, etc., used in the specification and patent application scope are used to modify components, and do not imply that the (or those) components have any prior ordinal numbers, nor do they represent an order of one component with another, or an order of a manufacturing method, the use of these ordinal numbers is only used to clearly distinguish a component with a certain name from another component with the same name. The same words may not be used in the patent claims and the description. Accordingly, the first component in the description may be the second component in the patent claims.

The electrical connection or coupling described in the disclosure may refer to direct connection or indirect connection. In the case of direct connection, terminals of components on two circuits are directly connected or connected to each other with a conductor line segment, and in the case of indirect connection, there are switches, diodes, capacitors, inductors, resistors, other suitable components, or combinations of the above components between the terminals of the components on the two circuits, but the disclosure is not limited thereto.

In the disclosure, the thickness, length and width may be measured by using an optical microscope (OM), and the thickness or width may be measured based on a cross-sectional image in an electron microscope, but the disclosure is not limited thereto. In addition, any two values or directions used for comparison may have certain errors. In addition, the terms “a given range is a first value to a second value”, “the given range falls within a range of the first value to the second value” or “the given range is between the first value and the second value” means that the given range includes the first value, the second value and other values therebetween. If a first direction is perpendicular to a second direction, an angle between the first direction and the second direction may be between 80 degrees and 100 degrees; if the first direction is parallel to the second direction, the angle between the first direction and the second direction may be between −10 degrees and 10 degrees.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the disclosure, the electronic device may include a display device, a backlight device, an antenna device, a packaging device, a sensing device or a splicing device, but the disclosure is not limited thereto. The electronic device may be a bendable or flexible electronic device. The display device may be a non-self-luminous display device or a self-luminous display device. The display device may include, for example, liquid crystal, light-emitting diode, fluorescence, phosphor, quantum dot (QD), other suitable display media, or a combination thereof. The antenna device may, for example, include a reconfigurable intelligent surface (RIS), a frequency selective surface (FSS), a radio frequency filter (RF-Filter), a polarizer, a resonator or an antenna, etc. The antenna may be a liquid crystal based antenna or a varactor diode based antenna. The sensing device may be a sensing device that senses capacitance, light, heat energy or ultrasonic waves, but the disclosure is not limited thereto. In the disclosure, the electronic device may include electronic components, and the electronic components may include passive components and active components, such as capacitors, resistors, inductors, diodes, transistors, etc. The diodes may include light-emitting diodes, varactor diodes or photodiodes. The light-emitting diodes may include, for example, organic light-emitting diodes (OLEDs), mini LEDs, micro LEDs or quantum dot LEDs, but the disclosure is not limited thereto. The splicing device may be, for example, a display splicing device or an antenna splicing device, but the disclosure is not limited thereto. It should be noted that the electronic device may be any combination of the above, but the disclosure is not limited thereto. The packaging device may be suitable for wafer-level package (WLP) technology or panel-level package (WLP) technology, such as chip a first process or a RDL first process. In addition, a shape of the electronic device may be a rectangular shape, a circular shape, a polygonal shape, a shape with curved edges, or other suitable shapes. The electronic device may have peripheral systems such as a driving system, a control system, and a light source system to support a display device, an antenna device, a wearable device (for example, including augmented reality or virtual reality), a vehicle-mounted device (for example, including a car windshield), or a splicing device.

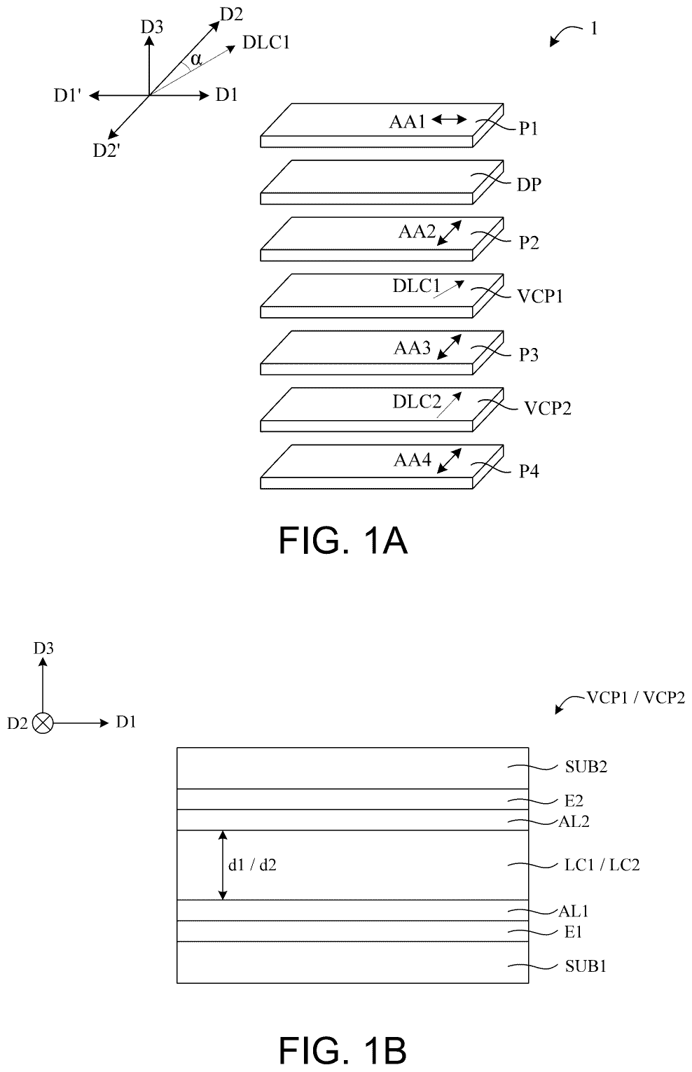

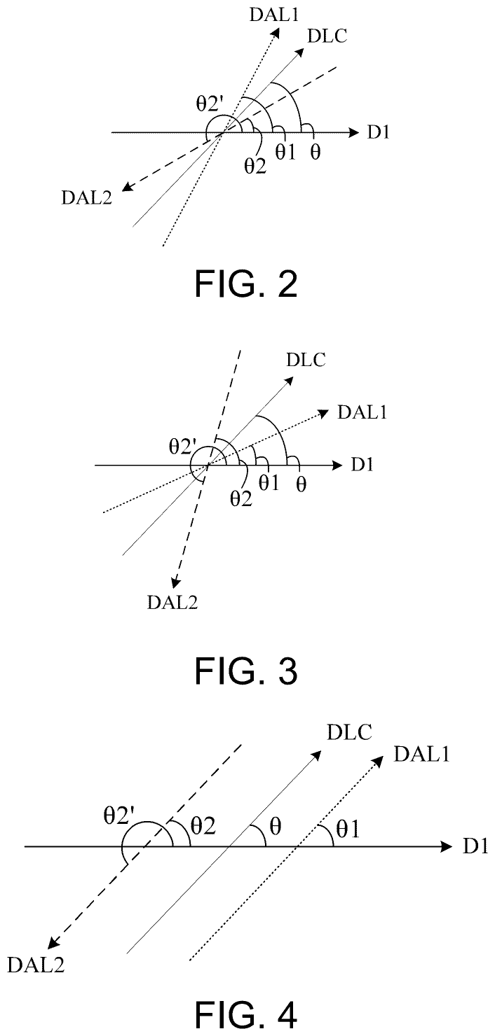

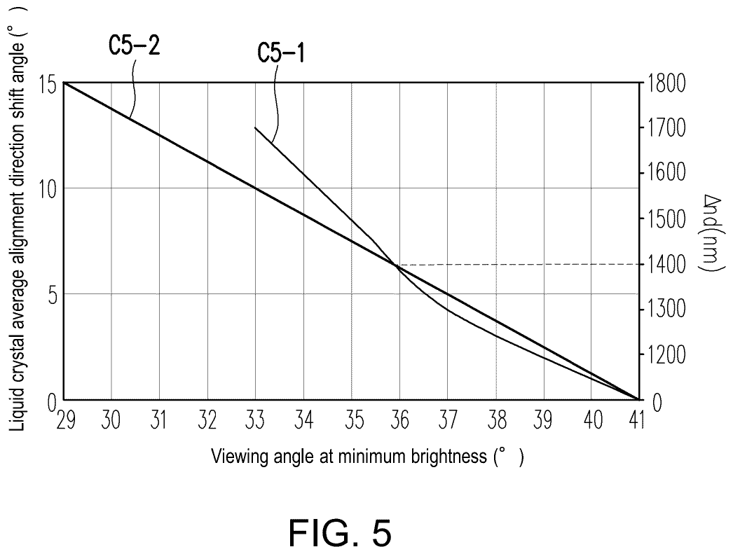

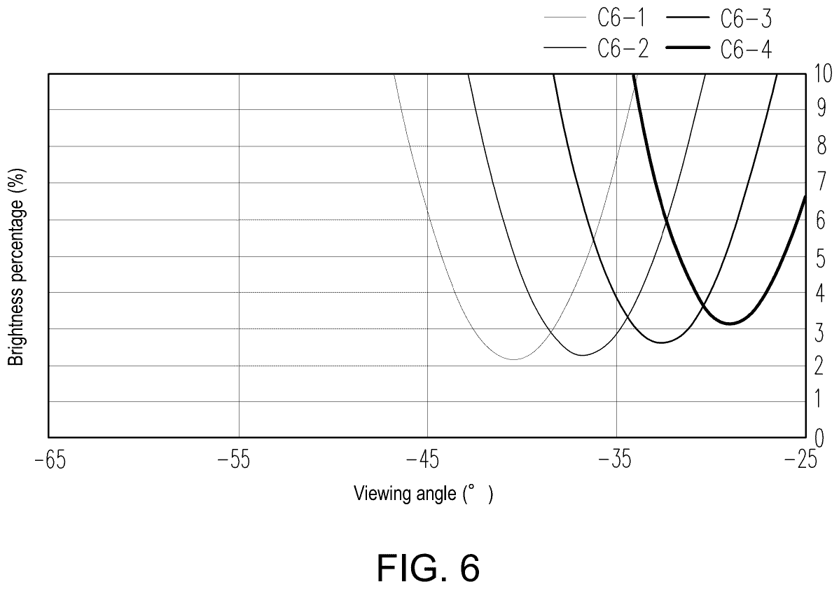

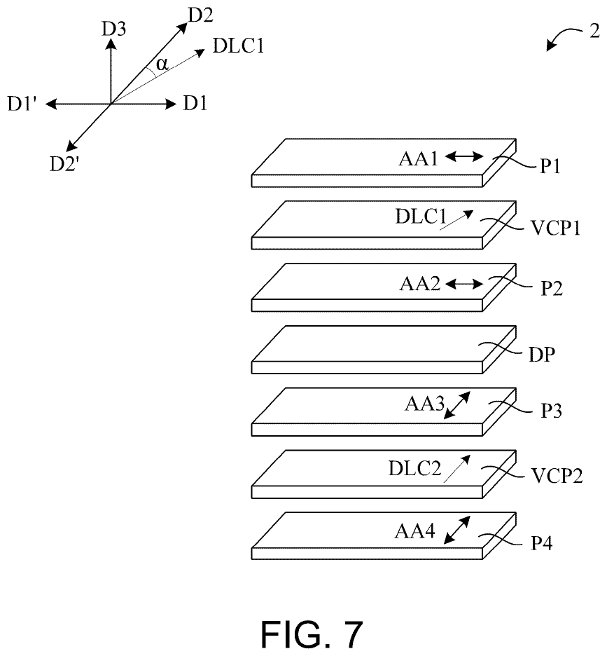

FIG. 1A is an exploded view of an electronic device according to a first embodiment of the disclosure. FIG. 1B is a schematic cross-sectional view of a first viewing angle control panel or a second viewing angle control panel in FIG. 1A. FIG. 2 to FIG. 4 are respectively schematic top views illustrating three relative arrangements of a liquid crystal average alignment direction, a first alignment direction of a first alignment layer, and a second alignment direction of a second alignment layer. FIG. 5 is a diagram illustrating a relationship between a liquid crystal average alignment shift angle, Δnd and a viewing angle at minimum brightness. FIG. 6 is a diagram illustrating a relationship between viewing angles and brightness percentage. FIG. 7 is an exploded view of an electronic device according to a second embodiment of the disclosure.

FIG. 8 to FIG. 10 are three schematic top views respectively illustrating three relative arrangements of the liquid crystal average alignment direction and a second direction. It should be noted that the following embodiments may be replaced, reorganized, and mixed with features of several different embodiments without departing from the spirit of the disclosure to complete other embodiments. Features in various embodiments may be mixed and matched as long as they do not violate the spirit of the invention or conflict with each other.

Referring to FIG. 1A and FIG. 1B, an electronic device 1 may include a first viewing angle control panel VCP1 and a second viewing angle control panel VCP2. The first viewing angle control panel VCP1 may include a first liquid crystal layer LC1. The first liquid crystal layer LC1 has a first liquid crystal refractive index difference value Δn1, a first liquid crystal layer spacing d1, and a first liquid crystal average alignment direction DLC1. The second viewing angle control panel VCP2 overlaps the first viewing angle control panel VCP1 and includes a second liquid crystal layer LC2. The second liquid crystal layer LC2 has a second liquid crystal refractive index difference value Δn2, a second liquid crystal layer spacing d2, and a second liquid crystal average alignment direction DLC2. A product of the first liquid crystal refractive index difference value Δn1 and the first liquid crystal layer spacing d1 (i.e., Δn1*d1) is different from a product of the second liquid crystal refractive index difference value Δn2 and the second liquid crystal layer spacing d2 (i.e., Δn2*d2), and the first liquid crystal average alignment direction DLC1 is different from the second liquid crystal average alignment direction DLC2.

In detail, the first viewing angle control panel VCP1 and/or the second viewing angle control panel VCP2 has a first edge and a second edge adjacent to the first edge. The first edge extends along a first direction D1, the second edge extends along a second direction D2, and the first viewing angle control panel VCP1 and the second viewing angle control panel VCP2 are, for example, overlapped in a thickness direction (such as the third direction D3) of the electronic device 1. The first direction D1 and the second direction D2 are both perpendicular to a third direction D3, and the first direction D1 and the second direction D2 intersect each other. In some embodiments, the first direction D1 and the second direction D2 are perpendicular to each other, but the disclosure is not limited thereto.

The first viewing angle control panel VCP1 and the second viewing angle control panel VCP2 are all, for example, electronically controlled viewing angle control panels. As shown in FIG. 1B, the electronically controlled viewing angle control panel (such as the first viewing angle control panel VCP1 or the second viewing angle control panel VCP2; marked with “VCP1/VCP2” in FIG. 1B) may include a first substrate SUB1, a second substrate SUB2, a first electrode layer E1, a second electrode layer E2, a first alignment layer AL1, a second alignment layer AL2 and a liquid crystal layer (such as a first liquid crystal layer LC1 or a second liquid crystal layer LC2;

marked with “LC1/LC2” in FIG. 1B).

The first substrate SUB1 and the second substrate SUB2 extend along the first direction D1 and the second direction D2, and the first substrate SUB1 and the second substrate SUB2 overlap in a thickness direction (such as the third direction D3) of the electronic device 1. The first substrate SUB1 and the second substrate SUB2 may be rigid substrates or flexible substrates.

Materials of the first substrate SUB1 and the second substrate SUB2 include, for example, glass, quartz, ceramics, sapphire or plastic, but the disclosure is not limited thereto. Plastics may include polycarbonate (PC), polyimide (PI), polypropylene (PP), polyethylene terephthalate (PET), and other suitable flexible materials. materials or combinations of the aforementioned materials, but the disclosure is not limited thereto.

The first electrode layer El and the second electrode layer E2 are located between the first substrate SUB1 and the second substrate SUB2 and are, for example, respectively disposed on the first substrate SUB 1 and the second substrate SUB2. Materials of the first electrode layer El and the second electrode layer E2 may include transparent conductive materials to reduce shielding of incident light. The transparent conductive material may include metal oxides, graphene, other suitable transparent conductive materials, or combinations thereof. The metal oxides may include indium tin oxide, indium zinc oxide, aluminum tin oxide, aluminum zinc oxide, indium germanium zinc oxide, or other metal oxides.

The first alignment layer AL1 and the second alignment layer AL2 are located between the first electrode layer E1 and the second electrode layer E2 and are, for example, respectively disposed on the first electrode layer E1 and the second electrode layer E2. Materials of the first alignment layer AL1 and the second alignment layer AL2 may include polyimide, but the disclosure is not limited thereto.

The liquid crystal layer (such as the first liquid crystal layer LC1 or the second liquid crystal layer LC2) is located between the first alignment layer AL1 and the second alignment layer AL2. The liquid crystal layer may include an electrically controlled birefringence (ECB) liquid crystal layer or a vertical alignment (VA) liquid crystal layer, but the disclosure is not limited thereto.

The liquid crystal refractive index difference value of the liquid crystal layer refers to a refractive index difference between a long axis and a short axis of liquid crystal molecules in the liquid crystal layer. For example, the first liquid crystal refractive index difference value Δn1 is the refractive index difference between the long axis and the short axis of the liquid crystal molecules in the first liquid crystal layer LC1, and the second liquid crystal refractive index difference value Δn2 is the refractive index difference between the long axis and the short axis of the liquid crystal molecules in the second liquid crystal layer LC2. In some embodiments, the first liquid crystal refractive index difference value Δn1 may be equal to the second liquid crystal refractive index difference value Δn2. In other embodiments, the first liquid crystal refractive index difference value Δn1 may not be equal to the second liquid crystal refractive index difference value Δn2.

The liquid crystal layer spacing (such as the first liquid crystal layer spacing d1 or the second liquid crystal layer spacing d2; marked with “d1/d2” in FIG. 1B) of the liquid crystal layer refers to the maximum thickness of the liquid crystal layer in the third direction D3. For example, the first liquid crystal layer spacing d1 is the maximum thickness of the first liquid crystal layer LC1 in the third direction D3, and the second liquid crystal layer spacing d2 is the maximum thickness of the second liquid crystal layer LC2 in the third direction D3. In the case that Δn1 is equal to Δn2, through the design that the first liquid crystal layer spacing d1 is not equal to the second liquid crystal layer spacing d2, Δn1*d1 (i.e., a phase retardation amount of the first liquid crystal layer LC1) is different from Δn2*d2 (i.e., a phase retardation amount of the second liquid crystal layer LC2). In the case that Δn1 is not equal to Δn2, the first liquid crystal layer spacing d1 may be equal to or not equal to the second liquid crystal layer spacing d2.

The liquid crystal average alignment direction (the first liquid crystal average alignment direction DLC1 or the second liquid crystal average alignment direction DLC2 in FIG. 1A) of the liquid crystal layer may be controlled by the first alignment layer AL1 and the second alignment layer AL2. Referring to FIG. 2 to FIG. 4, an included angle θ between the liquid crystal average alignment direction DLC and the first direction D1 is defined as θ1+(θ2−θ1)/2, i.e., θ=(θ1+θ2)/2. θ1 is an included angle between the first alignment direction DAL1 of the first alignment layer (referring to the first alignment layer AL1 in FIG. 1B) and the first direction D1, and the included angle is, for example, an angle formed by counterclockwise rotation from the first direction D1 to the first alignment direction DAL1, and 0°<θ1<360°. θ2=θ2′-180°, where θ2′ is an included angle between the second alignment direction DAL2 of the second alignment layer (referring to the second alignment layer AL2 in FIG. 1B) and the first direction D1. The included angle is, for example, an angle formed by counterclockwise rotation from the first direction D1 to the second alignment direction DAL2, and 0°<θ2′<360°. In other words, θ2 is an included angle between an opposite direction of the second alignment direction DAL2 and the first direction D1, and 0°<θ2<360°. FIG. 2 to FIG. 4 illustrate that three different first alignment directions DAL1 and corresponding three different second alignment directions DAL2 may obtain the same liquid crystal average alignment direction DLC. In any embodiment of the disclosure, any of the methods shown in FIG. 2 to FIG. 4 may be used to adjust the first liquid crystal average alignment direction of the first viewing angle control panel and the second liquid crystal average alignment direction of the second viewing angle control panel, so that the first liquid crystal average alignment direction is different from the second liquid crystal average alignment direction.

Referring to FIG. 5, FIG. 5 is a simulation result under an electronically controlled birefringence liquid crystal structure. Curve C5-1 is a relationship curve between Δnd and the viewing angle at the minimum brightness, and curve C5-2 is a relationship curve between a liquid crystal average alignment shift angle and the viewing angle at the minimum brightness. And refers to a phase retardation of the liquid crystal layer, i.e., a product of the liquid crystal refractive index difference value and the liquid crystal layer spacing. The viewing angle at the minimum brightness refers to a viewing angle at a best anti-peeping effect or a darkest brightness. The liquid crystal average alignment shift angle is, for example, an included angle between the liquid crystal average alignment direction and the second direction or the opposite direction of the second direction, such as an included angle a between the first liquid crystal average alignment direction DLC1 and the second direction in FIG. 1A.

According to FIG. 5, the viewing angle at the minimum brightness decreases as And increases. Therefore, the anti-peeping ability of small viewing angles may be improved by increasing And. However, An is determined by a liquid crystal material, so that an adjustable range of An is limited, and a main way to increase And is to increase the liquid crystal layer spacing. However, the larger the liquid crystal layer spacing is, the greater a usage amount of liquid crystal is. Due to process limitations and/or cost considerations, there is a limit to increase the liquid crystal layer spacing. In addition, according to FIG. 5, after And is greater than 1400 nm, reduction of the viewing angle at the minimum brightness gradually slows down. Namely, after

And is greater than 1400 nm, the ability to reduce the anti-peeping viewing angle by increasing And becomes worse. In comparison, the liquid crystal average alignment shift angle changes linearly with the viewing angle at the minimum brightness. The viewing angle at the minimum brightness decreases linearly as the liquid crystal average alignment shift angle increases. Therefore, in terms of design, based on process limitations, cost and/or efficiency considerations, a design using And together with the liquid crystal average alignment shift angle may be adopted. It should be understood that changing trends of the curve C5-1 and the curve C5-2 may vary based on a type of the liquid crystal. For example, under the electronically controlled birefringence liquid crystal structure, after And is greater than 1400 nm, the reduction of the viewing angle at the minimum brightness gradually slows down. Therefore, a design of And less than or equal to 1400 nm together with the liquid crystal average alignment shift angle may be adopted to improve the anti-peeping ability of small viewing angles. In other embodiments, for example, under a vertical alignment liquid crystal structure, after And is greater than 1100 nm, the reduction of the viewing angle at the minimum brightness gradually slows down. In other words, under the vertical alignment liquid crystal structure, a design of And less than or equal to 1100 nm together with the liquid crystal average alignment shift angle may be adopted to improve the anti-peeping ability of small viewing angles.

Referring to FIG. 6, a curve C6-1, a curve C6-2, a curve C6-3, and a curve C6-4 respectively represent brightness distribution curves at different viewing angles when the liquid crystal average alignment shift angle is 0 degree (i.e., the liquid crystal average alignment direction is parallel to the second direction), 5 degrees, 10 degrees and 15 degrees, where a lowest point of each curve is the viewing angle at the minimum brightness. In FIG. 6, a brightness percentage is a viewing angle brightness divided by a front viewing angle brightness multiplied by 100%. According to FIG. 6, the viewing angle at the minimum brightness decreases as the liquid crystal average alignment shift angle increases. Therefore, the anti-peeping ability of small viewing angles may be improved by increasing the liquid crystal average alignment shift angle.

Returning to FIG. 1A, through the design of Δn1*d1 being different from Δn2*d2, the first viewing angle control panel VCP1 and the second viewing angle control panel VCP2 may respectively be used to provide the anti-peeping effect for different viewing angles. In some embodiments, the product Δn1*d1 of the first liquid crystal refractive index difference value Δn1 and the first liquid crystal layer spacing d1 may be greater than the product Δn2*d2 of the second liquid crystal refractive index difference value Δn2 and the second liquid crystal layer spacing d2. In these embodiments, the first viewing angle control panel VCP1 may be used to improve the anti-peeping ability of small viewing angles, and the second viewing angle control panel VCP2 may be used to improve the anti-peeping ability of large viewing angles. In addition, in the embodiment in which the first viewing angle control panel VCP1 is used to improve the anti-peeping ability of small viewing angles, the first viewing angle control panel VCP1 may also adopt the above-mentioned design that the liquid crystal average alignment shift angle is not 0, so as to effectively reduce the anti-peeping viewing angle based on considerations of process limitations, cost and/or efficiency.

Taking FIG. 1A as an example, if the first direction D1 is an anti-peeping direction, the included angle α between the first liquid crystal average alignment direction DLC1 and the second direction D2 or the opposite direction D2′ of the second direction may be greater than 0 degree and less than 90 degrees, for example, greater than 0 degrees and less than or equal to 30 degrees, greater than 0 degrees and less than or equal to 15 degrees, but the disclosure is not limited thereto. It should be noted that an applicable range of the included angle a may vary based on the type of the liquid crystal. For example, when the electronically controlled birefringence liquid crystal layer is adopted, the included angle a is greater than 0 degrees and less than or equal to 15 degrees, and when the vertical alignment liquid crystal layer is adopted, the included angle a is greater than 0 degrees and less than or equal to 30 degrees. On the other hand, the second liquid crystal average alignment direction DLC2 may be parallel to the second direction D2.

In the case of left-hand drive, if the electronic device 1 is a display in front of the passenger, the design as shown in FIG. 1A or FIG. 8 may be used to improve the anti-peeping ability of the electronic device 1 at small viewing angles and reduce the influence of a display screen of the electronic device 1 near the driver's side on the driver. As shown in FIG. 1A, the included angle a may be the included angle between the first liquid crystal average alignment direction DLC1 and the second direction D2, and the included angle a may be, for example, an angle formed by clockwise rotation from the second direction D2 to the first liquid crystal average alignment direction DLC1, but the disclosure is not limited thereto. As shown in FIG. 8, the included angle a may also be the included angle between the first liquid crystal average alignment direction DLC1 and the opposite direction D2′ of the second direction, and the included angle α may be, for example, an angle formed by counterclockwise rotation from the opposite direction D2′ of the second direction to the first liquid crystal average alignment direction DLC1, but the disclosure is not limited thereto.

In the case of right-hand drive, if the electronic device 1 is a display in front of the

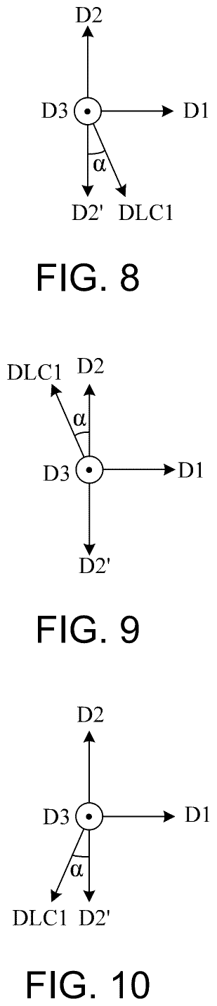

passenger, the anti-peeping ability of the electronic device 1 at small viewing angles may be improved through the design of FIG. 9 or FIG. 10, so as to reduce the influence of a display screen of the electronic device 1 near the driver's side on the driver. As shown in FIG. 9, the included angle a may be the included angle between the first liquid crystal average alignment direction DLC1 and the second direction D2, and the included angle α may be, for example, an angle formed by counterclockwise rotation from the second direction D2 to the first liquid crystal average alignment direction DLC1, but the disclosure is not limited thereto. As shown in FIG. 10, the included angle α may also be the included angle between the first liquid crystal average alignment direction DLC1 and the opposite direction D2′ of the second direction, and the included angle α may be, for example, an angle formed by clockwise rotation from the opposite direction D2′ of the second direction to the first liquid crystal average alignment direction DLC1, but the disclosure is not limited thereto.

Although the above description is based on the first direction D1 being the anti-peeping direction, the disclosure is not limited thereto. In other embodiments, the second direction D2 may be the anti-peeping direction. Under this structure, the included angle between the first liquid crystal average alignment direction DLC1 and the first direction D1 or the opposite direction D1′ of the first direction may be greater than 0 degree and less than 90 degrees, for example, greater than 0 degrees and less than or equal to 15 degrees (when using an electronically controlled birefringence liquid crystal layer) or greater than 0 degree and less than or equal to 30 degrees (when using a vertical alignment liquid crystal layer), to improve the anti-peeping ability of electronic devices at small viewing angles.

Returning to FIG. 1A, the electronic device 1 may also include other components or film layers according to different requirements. For example, the electronic device 1 may further include a first polarizer P1. The first polarizer P1 is disposed on the first viewing angle control panel VCP1 and the second viewing angle control panel VCP2, where an absorption axis AA1 of the first polarizer P1 is parallel to the first direction D1.

The first polarizer P1 is, for example, a polarizer closest to the user side in the electronic device 1. The first polarizer P1 may be a reflective polarizer or an absorptive polarizer, which is not limited by the disclosure. By making the absorption axis AA1 of the first polarizer P1 parallel to the first direction D1, the absorption of light from the electronic device 1 by sunglasses may be reduced, thereby mitigating the problem that the user cannot see the display screen due to wearing the sunglasses.

The electronic device 1 may further include a display panel DP. In some embodiments, the display panel DP may be disposed between the first polarizer P1 and the first viewing angle control panel VCP1, and the first viewing angle control panel VCP1 may be disposed between the display panel DP and the second viewing angle control panel VCP2, but the disclosure is not limited thereto. In the disclosure, the display panel DP may be a self-luminous display panel or a non-self-luminous display panel, which is not limited by the disclosure. If the display panel DP is a non-self-luminous display panel, the electronic device 1 may further include a backlight module (not shown), and the backlight module may be disposed on the side farthest from the user side in the electronic device 1.

The electronic device 1 may further include a second polarizer P2, a third polarizer P3, and a fourth polarizer P4. The second polarizer P2, the third polarizer P3, and the fourth polarizer P4 may be reflective polarizers or absorptive polarizers, which are not limited by the disclosure. The second polarizer P2 may be disposed between the display panel DP and the first viewing angle control panel VCP1, and the second polarizer P2 and the first polarizer P1 are respectively located on opposite sides of the display panel DP. In some embodiments, an absorption axis AA2 of the second polarizer P2 may be perpendicular to the absorption axis AA1 of the first polarizer P1 and parallel to the second direction D2.

The third polarizer P3 may be disposed between the first viewing angle control panel VCP1 and the second viewing angle control panel VCP2, and the third polarizer P3 and the second polarizer P2 are located on the same side of the display panel DP (for example, both are located on a lower side of the display panel DP). An absorption axis AA3 of the third polarizer P3 may be parallel to the absorption axis AA2 of the second polarizer P2.

The second viewing angle control panel VCP2 may be disposed between the third polarizer P3 and the fourth polarizer P4, and the fourth polarizer P4, the third polarizer P3 and the second polarizer P2 may be located on the same side of the display panel DP (for example, located on the lower side of the display panel DP). An absorption axis AA4 of the fourth polarizer P4 may be parallel to the absorption axis AA3 of the third polarizer P3 and the absorption axis AA2 of the second polarizer P2.

Since the display panel DP may scatter light, which affects the anti-peeping effect, when the display panel DP is set on the first viewing angle control panel VCP1 and the second viewing angle control panel VCP2, the first viewing angle control panel VCP1 may be made closer to the display panel DP than the second viewing angle control panel VCP2 (i.e., the first viewing angle control panel VCP1 is located between the second viewing angle control panel VCP2 and the display panel DP), so as to reduce the influence of the display panel DP on the anti-peeping effect of small viewing angles.

In some embodiments, although not shown in FIG. 1A, the electronic device 1 may further include one or a plurality of compensation films, such as one or a plurality of -C plates, but the disclosure is not limited thereto. The one or plurality of compensation films may be disposed between the second polarizer P2 and the first viewing angle control panel VCP1, between the first viewing angle control panel VCP1 and the third polarizer P3, between the third polarizer P3 and the second viewing angle control panel VCP2 and/or between the second viewing angle control panel VCP2 and the fourth polarizer P4.

Referring to FIG. 7, main differences between the electronic device 2 and the electronic device 1 in FIG. 1A are described below. In the electronic device 2, the positions of the first viewing angle control panel VCP1 and the display panel DP are reversed, so that the first viewing angle control panel VCP1 is disposed between the first polarizer P1 and the display panel DP, and the display panel DP is disposed between the first viewing angle control panel VCP1 and the second viewing angle control panel VCP2. As shown in FIG. 7, the second viewing angle control panel VCP2, the third polarizer P3, the display panel DP, the second polarizer P2, the first viewing angle control panel VCP1 and the first polarizer P1 are, for example, stacked sequentially on the fourth polarizer P4, where the second polarizer P2 and the first polarizer P1 are located on the same side of the display panel DP (for example, both are located on an upper side of the display panel DP), and the absorption axis AA2 of the second polarizer P2 is parallel to the absorption axis AA1 of the first polarizer P1. The third polarizer P3 and the second polarizer P2 are respectively located on opposite sides of the display panel DP, and the absorption axis AA3 of the third polarizer P3 is, for example, perpendicular to the absorption axis AA2 of the second polarizer P2. The fourth polarizer P4 and the third polarizer P3 are located on the same side of the display panel DP (for example, both are located on the lower side of the display panel DP). The absorption axis AA4 of the fourth polarizer P4 may be parallel to the absorption axis AA3 of the third polarizer P3. The display panel DP may be a self-luminous display panel or a non-self-luminous display panel, which is not limited by the disclosure.

In the structure in which the display panel DP is disposed between the first viewing angle control panel VCP1 and the second viewing angle control panel VCP2, the first viewing angle control panel VCP1 may be disposed on the user side to improve the anti-peeping ability of small viewing angles.

In some embodiments, although not shown in FIG. 7, the electronic device 2 may also include one or a plurality of compensation films, such as one or a plurality of -C plates, but the disclosure is not limited thereto. The one or plurality of compensation films may be disposed between the first polarizer P1 and the first viewing angle control panel VCP1, between the first viewing angle control panel VCP1 and the second polarizer P2, between the third polarizer P3 and the second viewing angle control panel VCP2 and/or between the second viewing angle control panel VCP2 and the fourth polarizer P4.

In other embodiments, although not shown, the display panel DP may be disposed below the first viewing angle control panel VCP1 and the second viewing angle control panel VCP2. For example, the display panel DP, the third polarizer P3, the second viewing angle control panel VCP2, the second polarizer P2, the first viewing angle control panel VCP1 and the first polarizer P1 may be sequentially stacked on the fourth polarizer P4. Under this structure, the absorption axis AA1 of the first polarizer P1, the absorption axis AA2 of the second polarizer

P2, and the absorption axis AA3 of the third polarizer P3 may be parallel to the first direction D1, and the absorption axis AA4 of the fourth polarizer P4 may be parallel to the second direction D2. In addition, the electronic device may further include one or a plurality of compensation films, such as one or a plurality of -C plates, but the disclosure is not limited thereto. The one or plurality of compensation films may be disposed between the first polarizer P1 and the first viewing angle control panel VCP1, between the first viewing angle control panel VCP1 and the second polarizer P2, between the second polarizer P2 and the second viewing angle control panel VCP2 and/or between the second viewing angle control panel VCP2 and the third polarizer P3. The display panel DP may be a self-luminous display panel or a non-self-luminous display panel, which is not limited by the disclosure.

In some other embodiments, although not shown, the display panel DP, the third polarizer P3, the first viewing angle control panel VCP1, the second polarizer P2, the second viewing angle control panel VCP2 and the first polarizer P1 may be sequentially stacked on the fourth polarizer P4. Under this structure, the absorption axis AA1 of the first polarizer P1, the absorption axis AA2 of the second polarizer P2, and the absorption axis AA3 of the third polarizer P3 may be parallel to the first direction D1, and the absorption axis AA4 of the fourth polarizer P4 may be parallel to the second direction D2. In addition, the electronic device may further include one or a plurality of compensation films, such as one or a plurality of -C plates, but the disclosure is not limited thereto. The one or plurality of compensation films may be disposed between the first polarizer P1 and the second viewing angle control panel VCP2, between the second viewing angle control panel VCP2 and the second polarizer P2, between the second polarizer P2 and the first viewing angle control panel VCP1 and/or between the first viewing angle control panel VCP1 and the third polarizer P3. The display panel DP may be a self-luminous display panel or a non-self-luminous display panel, which is not limited by the disclosure.

In summary, in the embodiments of the disclosure, through the design that the product of the first liquid crystal refractive index difference value and the first liquid crystal layer spacing is different from the product of the second liquid crystal refractive index difference value and the second liquid crystal layer spacing, the first viewing angle control panel and the second viewing angle control panel may be used respectively to provide the anti-peeping effect for different viewing angles. In addition, the anti-peeping ability of small viewing angles may be improved through the liquid crystal average alignment shift angle (making the first liquid crystal average alignment direction to be different from the second liquid crystal average alignment direction).

The above embodiments are only used to illustrate the technical solutions of the disclosure, but not to limit them; although the disclosure has been described in detail with reference to the foregoing embodiments, those with ordinary knowledge in the technical field should understand that: they may still modify the technical solutions recorded in the aforementioned embodiments, or equivalently replace some or all of the technical features; and these modifications or replacements do not make the essence of the corresponding technical solutions deviate from the scope of the disclosed embodiments.

Although the embodiments of the disclosure and their advantages have been disclosed above, it should be understood that anyone with ordinary knowledge in the art may make changes, substitutions and modifications without departing from the spirit and scope of the disclosure, and the features of each embodiment may be arbitrarily mixed and replaced with each other to form other new embodiments. In addition, the protection scope of the disclosure is not limited to the processes, machines, manufacturing, material compositions, devices, methods and steps in the specific embodiments described in the specification, and anyone with ordinary skill in the art may understand the current or future developed processes, machines, manufacturing, material compositions, devices, methods and steps based on the content disclosed in the disclosure, as long as the substantially same functions may be implemented or substantially same results may be obtained in the embodiments described here, they may be used according to this disclosure.

Therefore, the protection scope of the disclosure includes the above-mentioned processes, machines, manufacturing, material compositions, devices, methods and steps. In addition, each claim constitutes an individual embodiment, and the protection scope of the disclosure also includes combinations of each claim and embodiment. The protection scope of the disclosure shall be determined by the accompanying claims.

What is claimed is:

1. An electronic device, comprising:
a first viewing angle control panel, comprising a first liquid crystal layer, wherein the first liquid crystal layer has a first liquid crystal refractive index difference value, a first liquid crystal layer spacing, and a first liquid crystal average alignment direction; and
a second viewing angle control panel, overlapping the first viewing angle control panel and comprising a second liquid crystal layer, wherein the second liquid crystal layer has a second liquid crystal refractive index difference value, a second liquid crystal layer spacing, and a second liquid crystal average alignment direction,
wherein a product of the first liquid crystal refractive index difference value and the first liquid crystal layer spacing is different from a product of the second liquid crystal refractive index difference value and the second liquid crystal layer spacing, and the first liquid crystal average alignment direction is different from the second liquid crystal average alignment direction.

2. The electronic device as claimed in claim 1, wherein the product of the first liquid crystal refractive index difference value and the first liquid crystal layer spacing is greater than the product of the second liquid crystal refractive index difference value and the second liquid crystal layer spacing.

3. The electronic device as claimed in claim 2, wherein the first viewing angle control panel has a first edge and a second edge, the first edge extends along a first direction, the second edge extends along a second direction, the first direction is an anti-peeping direction, the second direction is perpendicular to the first direction, and an included angle between the first liquid crystal average alignment direction and the second direction or an opposite direction of the second direction is greater than 0 degree and less than 90 degrees.

4. The electronic device as claimed in claim 3, wherein the included angle is greater than 0 degree and less than or equal to 30 degrees.

5. The electronic device as claimed in claim 4, wherein the first liquid crystal layer is a vertical alignment liquid crystal layer.

6. The electronic device as claimed in claim 5, wherein the product of the first liquid crystal refractive index difference value and the first liquid crystal layer spacing is less than or equal to 1100 nm.

7. The electronic device as claimed in claim 3, wherein the included angle is greater than 0 degree and less than or equal to 15 degrees.

8. The electronic device as claimed in claim 7, wherein the first liquid crystal layer is an electrically controlled birefringence liquid crystal layer.

9. The electronic device as claimed in claim 8, wherein the product of the first liquid crystal refractive index difference value and the first liquid crystal layer spacing is less than or equal to 1400 nm.

10. The electronic device as claimed in claim 3, wherein the second liquid crystal average alignment direction is parallel to the second direction.

11. The electronic device as claimed in claim 3, further comprising:
a first polarizer, disposed on the first viewing angle control panel, wherein an absorption axis of the first polarizer is parallel to the first direction.

12. The electronic device as claimed in claim 11, further comprising:
a display panel, disposed between the first polarizer and the first viewing angle control panel.

13. The electronic device as claimed in claim 12, wherein the first viewing angle control panel is disposed between the display panel and the second viewing angle control panel.

14. The electronic device as claimed in claim 13, further comprising:
a second polarizer, disposed between the display panel and the first viewing angle control panel;
a third polarizer, disposed between the first viewing angle control panel and the second viewing angle control panel; and
a fourth polarizer, wherein the second viewing angle control panel is disposed between the third polarizer and the fourth polarizer.

15. The electronic device as claimed in claim 14, wherein an absorption axis of the second polarizer, an absorption axis of the third polarizer, and an absorption axis of the fourth polarizer are parallel to the second direction.

16. The electronic device as claimed in claim 11, further comprising:
a display panel, wherein the first viewing angle control panel is disposed between the first polarizer and the display panel.

17. The electronic device as claimed in claim 12, wherein the display panel is disposed between the first viewing angle control panel and the second viewing angle control panel.

18. The electronic device as claimed in claim 17, further comprising:
a second polarizer, disposed between the first viewing angle control panel and the display panel;
a third polarizer, disposed between the display panel and the second viewing angle control panel; and
a fourth polarizer, wherein the second viewing angle control panel is disposed between the third polarizer and the fourth polarizer.

19. The electronic device as claimed in claim 18, wherein an absorption axis of the second polarizer is parallel to the first direction, and an absorption axis of the third polarizer and an absorption axis of the fourth polarizer are parallel to the second direction.

20. The electronic device as claimed in claim 18, further comprising:
one or a plurality of compensation films, disposed at at least one of the following locations:
between the first polarizer and the first viewing angle control panel;
between the first viewing angle control panel and the second polarizer;
between the third polarizer and the second viewing angle control panel; and
between the second viewing angle control panel and the fourth polarizer.
